(19) United States
(12) Patent Application Publication
(10) Pub. No.: US 2006/0017763 A1
(43) Pub. Date: Jan. 26, 2006

(54) METHOD FOR INSPECTING WHETHER A PRINTHEAD OF A PRINTER CONFORMS TO A SPECIFICATION

(76) Inventor: Po-Chin Yang, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/161,169

(22) Filed: Jul. 25, 2005

(30) Foreign Application Priority Data
Jul. 26, 2004 (TW) 093122318

(51) Int. Cl. B41J 29/393

(52) U.S. Cl. 347/19

(57) ABSTRACT

A method for inspecting whether a printhead of a printer conforms to a specification. The method includes detecting if the number of damaged nozzles of the printhead is two. If the number of damaged nozzles of the printhead is two, then detect whether the two damaged nozzles can be tolerated according to the specification.

### BACKGROUND OF INVENTION

1. Field of the Invention

The present invention relates to a method for inspecting whether a printhead of a printer conforms to a specification, and more particularly, to a method for inspecting, by a scanner or the naked eye, whether a printhead of a printer conforms to a specification.

2. Description of the Prior Art

In modern society, an inkjet printer has become the most popular form of printing equipment because of its fair price and outstanding printing qualities. Due to the demand for high resolution printing quality, the manufacturers have developed inkjet printers with high quality and high speed. Therefore, such a printer must have a printhead having properties of high resolution printing quality through the use of multi-nozzles. However, it is difficult to improve the yield of inkjet chips without damaged nozzles. Additionally, it has been proven that two damaged nozzles are tolerated for high resolution printing quality. However, it is insufficient to inspect whether the number of damaged nozzles is less than three for inspecting printheads.

Suppose that there are two damaged nozzles in a printhead. The positions of dots jetted by the two damaged nozzles are not adjacent on a print-medium. After printing a printing block, there are two blank lines within the printing block due to the two damaged nozzles with each blank line generated by one damaged nozzle. Therefore, the width of each blank line is so narrow that it has no effect on high resolution printing quality. However, if the positions of dots jetted by the two damaged nozzles were adjacent on the print-medium, the printing block would have a blank area, such as the blank area 8 of FIG. 1. The two damaged nozzles generate the blank area 8. The width of the blank area 8 is wide and obvious. Therefore, printing quality is reduced. Consequently, for printheads having multi-nozzles and high resolution, it is insufficient to inspect whether the number of damaged nozzles is less than three for high resolution printing quality. Another method for inspecting printheads precisely and easily is needed.

### SUMMARY OF INVENTION

It is therefore a primary objective of the claimed invention to provide a method for inspecting whether a printhead of a printer conforms to a specification to solve the above-mentioned problem.

The claimed invention provides a method for inspecting whether a printhead of a printer conforms to a specification. The method includes detecting if the number of damaged nozzles of the printhead is two. If the number of damaged nozzles of the printhead is two, it is determined whether the two damaged nozzles can be tolerated according to the specification.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an image printed by an unqualified printhead according to the prior art.

FIG. 2 is a diagram of a first embodiment of the present invention for inspecting a printhead having two damaged nozzles.

FIG. 3 to FIG. 6 are test patterns for a printhead having an even number of nozzles according to the present invention.

FIG. 7 is a diagram of a second embodiment of the present invention for inspecting a printhead having two damaged nozzles.

FIG. 8 to FIG. 10 are test patterns for a printhead having an odd number of nozzles according to the present invention.

FIG. 11 is a diagram of the printer of the present invention.

FIG. 12 is a flowchart of inspecting whether a printhead having an odd number of nozzles conforms to the specification.

FIG. 13 is a flowchart of inspecting whether a printhead having an even number of nozzles conforms to the specification.

### DETAILED DESCRIPTION

The present invention provides a method for inspecting high resolution printheads. The present invention determines if the number of damaged nozzles is equal to or less than two. When the number of damaged nozzles is two, an interpolation is used for inferring which positions of dots jetted by the two damaged nozzles can be tolerated for high resolution printing quality. Since two damaged nozzles are tolerated for multi-nozzled, high-resolution printheads, the present invention inspects the number of damaged nozzles in a printhead. If the number of damaged nozzles is greater than two, the printhead does not conform to the specification. If the number of damaged nozzles is less than two, the printhead conforms to the specification. If the number of damaged nozzles is two and the positions of dots jetted by the two damaged nozzles are not adjacent on a print-medium, the printhead conforms to the specification.

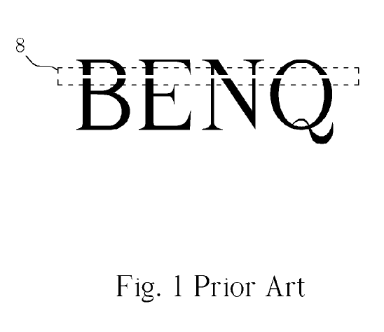

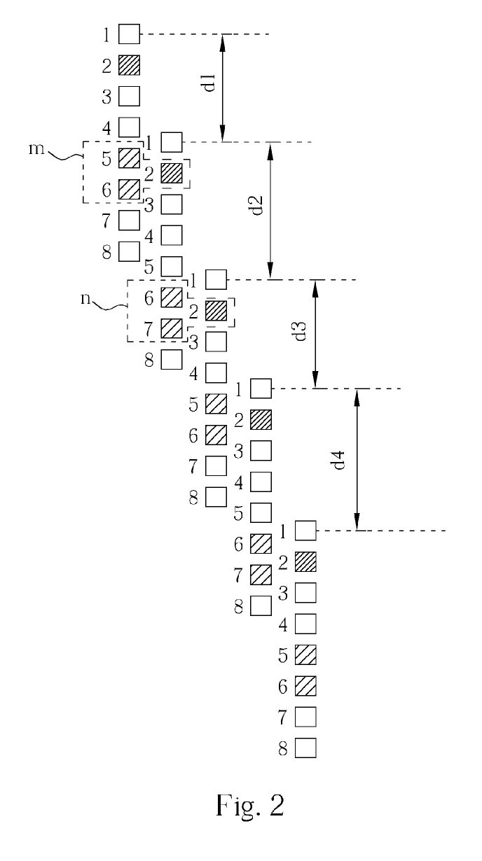

Please refer to FIG. 2. FIG. 2 is a diagram of the first embodiment of the present invention for inspecting a printhead having two damaged nozzles. In FIG. 2, the number N of nozzles of the printhead is eight (an even number). After the printhead completes a printing pass on a print-medium, the print-medium moves a distance d1 of 3.5 nozzles. After the printhead completes the next printing pass, the print-medium moves a distance d2 of 4.5 nozzles. Next, after the printhead completes another printing pass, the print-medium moves a distance d3 of 3.5 nozzles, prints, and then moves a distance d4 of 4.5 nozzles and completes another printing pass. The print-medium moves distances of 3.5 nozzles and 4.5 nozzles alternately. Suppose that one of the two damaged nozzles is the 2nd nozzle, marked with thick lines. In this case, the other damaged nozzle could not be the 5th, 6th, or 7th nozzle, marked with thin lines. If the other damaged nozzle is the 5th or 6th nozzle, when the print-medium moves a distance of 3.5 nozzles, the positions of the 2nd and the 5th or 6th nozzles are adjacent on the print-medium as the block m of FIG. 2. Therefore, after the printhead completes a printing pass, the blank area 8 of FIG. 1 will occur. Similarly, if the other damaged nozzle is the 6th or 7th nozzle, when the print-medium moves a distance of 4.5 nozzles, the positions of the 2nd and the 6th or 7th nozzles are adjacent on the print-medium as the block n of FIG. 2 and then the blank area 8 of FIG. 1 will occur.

We can infer a conclusion from the above. The number of damaged nozzles of the printhead is two and the number of nozzles of the printhead is even. After the printhead completes a printing pass, the moving distance of the print-medium is equal to a distance from the first nozzle to the middle of the N/2 nozzle and the (N+2)/2 nozzle. After the next printing pass, the moving distance of the print-medium is equal to a distance from the first nozzle to the middle of the (N+2)/2 nozzle and the (N+4)/2 nozzle. That is, the print-medium moves two different distances alternately. Suppose that one of the two damaged nozzles is the n nozzle, if the other damaged nozzle conforms to one of the following three rules, the printhead is unqualified.
(a1) When n=1 to (N/2)−1, the other damaged nozzle is the (N/2)+n−1 nozzle, the (N/2)+n nozzle, or the (N/2)+n+1 nozzle;
(a2) When n=N/2, the other damaged nozzle is the (N−1) nozzle, or the N nozzle;
(a3) When n=(N/2)+1, the other damaged nozzle is the N nozzle.

Note that the conditions of n=(N/2)+2 to N are included in the three rules. For instance, from the three rules, if one of the two damaged nozzles is the N nozzle, the other damaged nozzle cannot be the (N/2)−1, N/2, or (N/2)+1 nozzle. If there are only two damaged nozzles, and the first to the (N/2)+1 nozzles are not damaged, the printhead must conform to the specification.

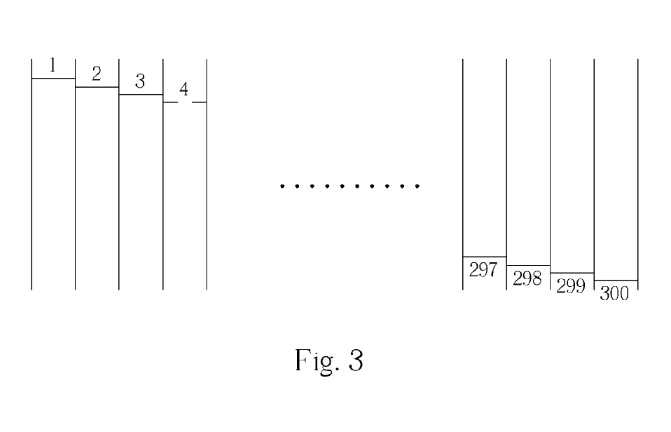

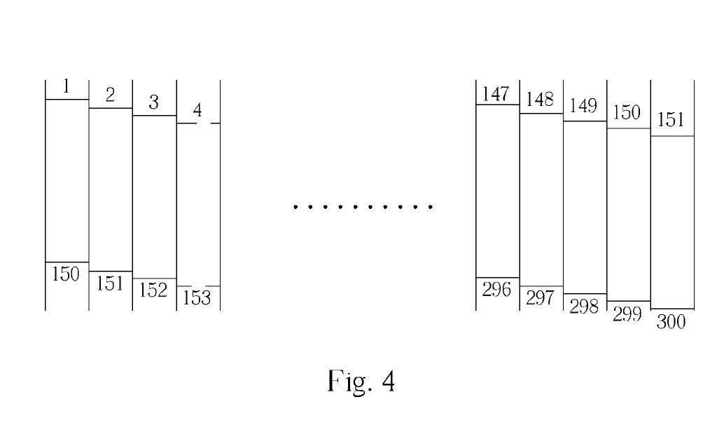

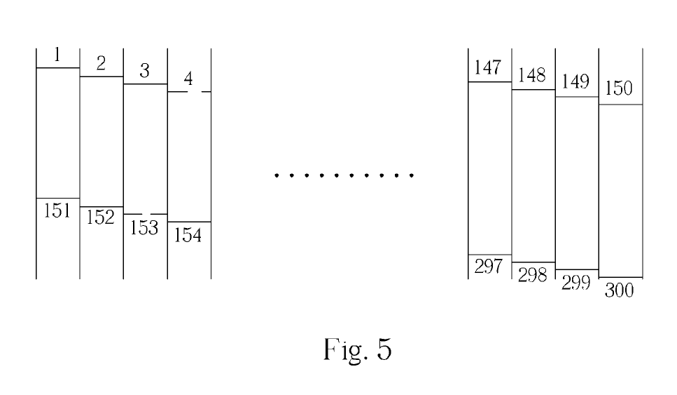

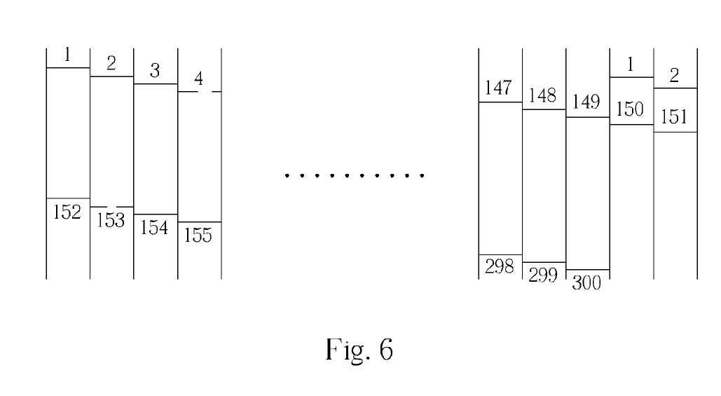

According to the three rules, the present invention designs test patterns for the printhead having an even number of nozzles. Please refer to FIG. 3 to FIG. 6, which are test patterns for the printhead having an even number of nozzles according to the present invention. The number of nozzles of the printhead of FIG. 3 to FIG. 6 is 300. FIG. 3 is the first test pattern. Each set prints a line by a nozzle. Thus, there are 300 sets in FIG. 3. The number of damaged nozzles can be inspected with the naked eye from FIG. 3. For example, the line is not complete in the 4th set of FIG. 3. In other words, the 4th nozzle is damaged. If the number of damaged nozzles is two from the inspection of FIG. 3. The test patterns of FIG. 4 to FIG. 6 must be printed for further inspection. In FIG. 4 to FIG. 6, each set has two lines printed by two nozzles respectively. If one of the two damaged nozzles is the first nozzle (n=1), according to the rule (a1), the other damaged nozzle could not be the 150th, 151st, or 152nd nozzle. Therefore, the first and the 150th nozzles jet ink in the same set in FIG. 4; the first and the 151st nozzles jet ink in the same set in FIG. 5; and the first and the 152nd nozzles jet ink in the same set in FIG. 6. If one of the two damaged nozzles is the second nozzle (n=2), the other damaged nozzle could not be the 151st, 152nd, or 153rd nozzle, as shown in the second set of FIG. 4 to FIG. 6. Thus, the test patterns of FIG. 4 to FIG. 6 can be designed according to the three rules. There are 151 sets in FIG. 4 and FIG. 6, and there are 150 sets in FIG. 5. If two lines of any set of FIG. 4 to FIG. 6 are not complete, the printhead is unqualified. For instance, the two lines of the 4th set of FIG. 4 are not complete. We can infer that the 4th and 153rd nozzles are damaged and the printhead is unqualified. The arrangement of each set of FIG. 4 to FIG. 6 is random. If two lines of any set are not complete, the printhead is unqualified.

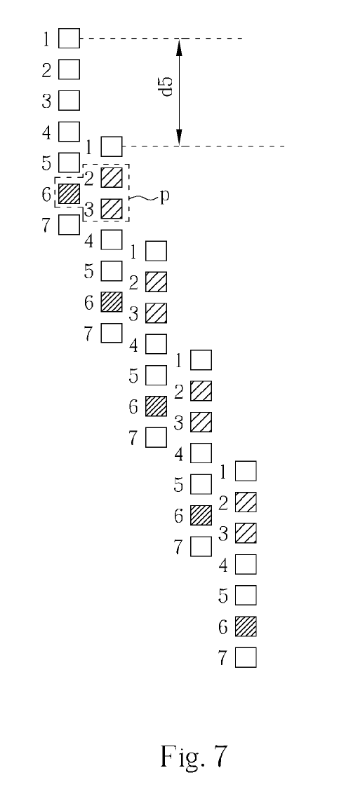

Please refer to FIG. 7, which is a diagram of the second embodiment of the present invention for inspecting the printhead having two damaged nozzles. In the embodiment of FIG. 7, the number N of nozzles of the printhead is seven (an odd number). After the printhead completes a printing pass on a print-medium, the print-medium moves a distance d5 of 3.5 nozzles. Suppose that one of the two damaged nozzles is the 6th nozzle, marked with thick lines. In this case, the other damaged nozzle could not be the 2nd or 3rd nozzle, marked with thin lines. If the other damaged nozzle is the 2nd or 3rd nozzle, when the print-medium moves a distance of 3.5 nozzles, the positions of the 6th and the 2nd or 3rd nozzles are adjacent on the print-medium as the block p of FIG. 7. Therefore, the blank area 8 of FIG. 1 will occur.

We can infer a conclusion from the above. The number of damaged nozzles of the printhead is two and the number of nozzles of the printhead is odd. After the printhead completes a printing pass, the moving distance of the print-medium is equal to a distance from the first nozzle to the middle of the (N+1)/2 nozzle and the (N+3)/2 nozzle. Suppose that one of the two damaged nozzles is the n nozzle. If the other damaged nozzle conforms to one of the following two rules, the printhead is unqualified.
(b1) When n=1 to (N−1)/2, the other damaged nozzle is the ((N−1)/2+n) nozzle, or the ((N+1)/2+n) nozzle;
(b2) When n=(N+1)/2, the other damaged nozzle is the N nozzle.

Note that the conditions of n=(N+1)/2+ to N are included in the two rules. For instance, from the two rules, if one of the two damaged nozzles is the N nozzle, the other damaged nozzle could not be the (N+1)/2, or (N−1)/2 nozzle. If there are only two damaged nozzles, and the first to the (N+1)/2 nozzles are not damaged, the printhead must conform to the specification.

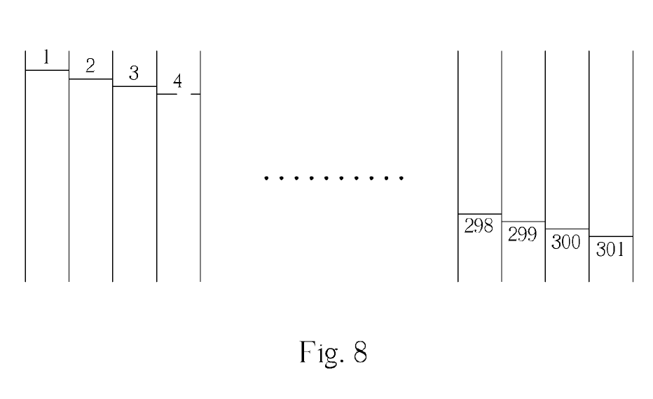

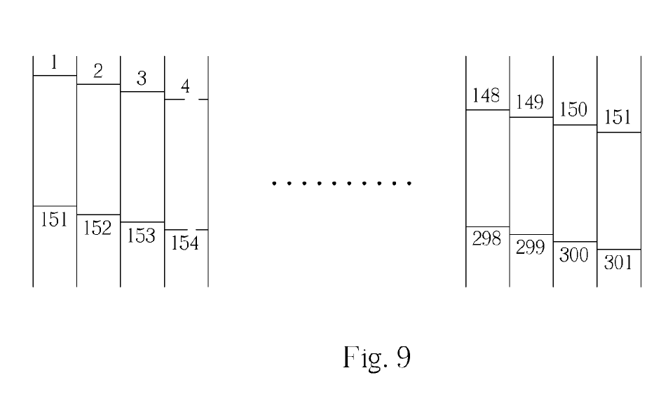

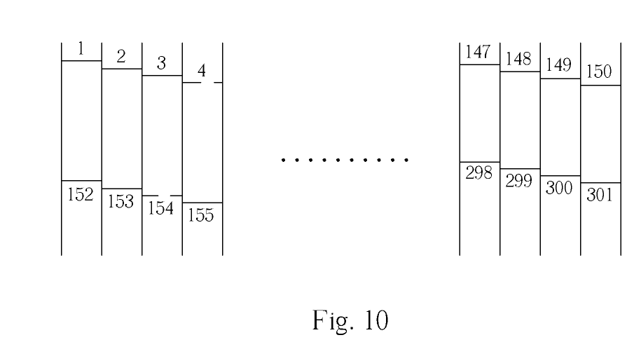

According to the two rules, the present invention designs test patterns for the printhead having an odd number of nozzles. Please refer to FIG. 8 to FIG. 10, which are test patterns according to the present invention for the printhead having an odd number of nozzles. The number of nozzles of the printhead of FIG. 8 to FIG. 10 is 301. FIG. 8 is the first test pattern. Each set prints a line by a single nozzle. Thus, there are 301 sets in FIG. 8. The number of damaged nozzles can be inspected with the naked eye from FIG. 8. For example, the line is not complete in the 4th set of FIG. 8. In other words, the 4th nozzle is damaged. If the number of damaged nozzles is two from the inspection of FIG. 8. The test patterns of FIG. 9 and FIG. 10 must be printed for further inspection. In FIG. 9 and FIG. 10, each set has two lines printed by two nozzles respectively. If one of the two damaged nozzles is the first nozzle (n=1), according to the rule (b1), the other damaged nozzle cannot be the 151st or 152nd nozzle. Therefore, the first and the 151st nozzles jet ink in the same set in FIG. 9 and the first and the 152nd nozzles jet ink in the same set in FIG. 10. If one of the two damaged nozzles is the second nozzle (n=2), the other damaged nozzle could not be the 152nd or 153rd nozzle, as shown in the second set of FIG. 9 and FIG. 10. Thus, the test patterns of FIG. 9 and FIG. 10 can be designed according to the two rules. There are 151 sets in FIG. 9 and there are 150 sets in FIG. 10. If two lines of any set of FIG. 9 and FIG. 10 are not complete, the printhead is unqualified. For instance, the two lines of the 4th set of FIG. 9 are not complete. We can infer that the 4th and 154th nozzles are damaged and the printhead is unqualified. The arrangement of each set of FIG. 9 and FIG. 10 is random. If two lines of any set are not complete, the printhead is unqualified.

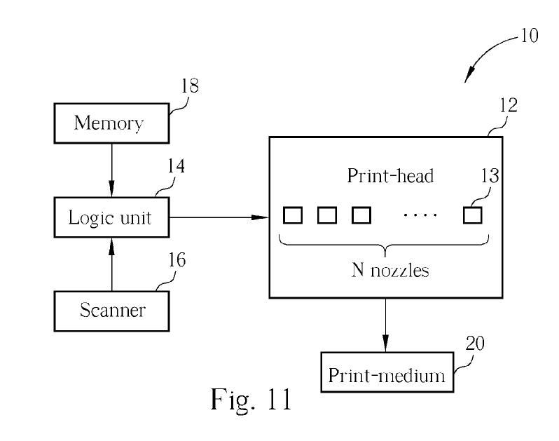

Additionally, the present invention can use a scanner for the inspection. Please refer to FIG. 11, which is a diagram of a printer 10 of the present invention. The printer 10 includes a printhead 12 having N nozzles 13 and a logic unit 14. The logic unit 14 inspects whether the printhead 12 conforms to the specification according to the rules mentioned above. The logic unit 14 draws a test pattern of FIG. 3 or FIG. 8 from a memory 18 and controls the printhead 12 to print the test pattern on a print-medium 20. A scanner 16 scans the test pattern printed on the print-medium 20. Then the logic unit 14 inspects whether the printhead 12 conforms to the specification according to the scan result of the scanner 16 and the rules mentioned above.

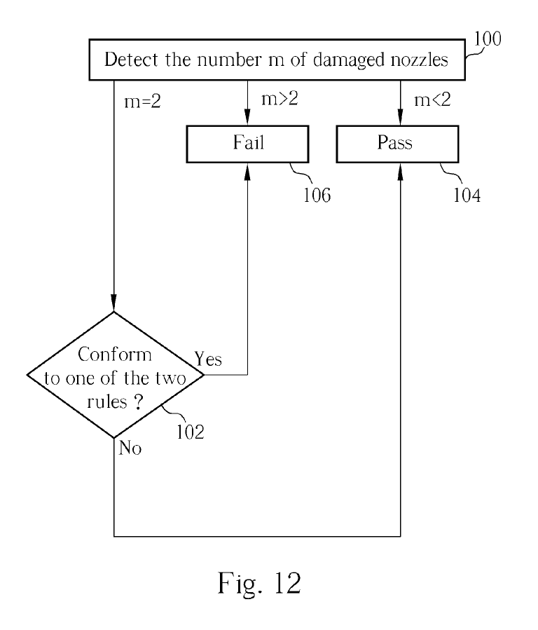

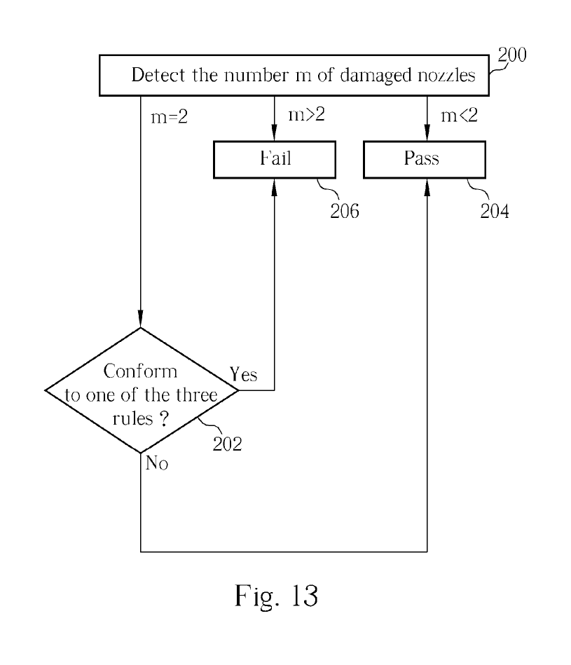

Before starting the flowchart of the present invention, whether the number of nozzles of the printhead 12 is odd or even must first be determined. The detailed steps are shown in FIG. 12 and FIG. 13. FIG. 12 and FIG. 13 are respective flowcharts of inspecting whether a printhead having odd and even nozzles conforms to the specification, respectively.

Please refer to FIG. 12 for the number of nozzles being odd.

Step 100: Detect the number m of all damaged nozzles. If m is smaller than 2, go to step 104. If m is greater than 2, go to step 106. If m is equal to 2, go to step 102.

Step 102: If the two damaged nozzles conform to one of the rules (b1) and (b2), go to step 106. Otherwise, go to step 104.

Step 104: The printhead is qualified.

Step 106: The printhead is unqualified.

Next, refer to FIG. 13 for the number of nozzles being even.

Step 200: Detect the number m of all damaged nozzles. If m is smaller than 2, go to step 204. If m is greater than 2, go to step 206. If m is equal to 2, go to step 202.

Step 202: If the two damaged nozzles conform to one of the rules (a1) and (a3), go to step 206. Otherwise, go to step 204.

Step 204: The printhead is qualified.

Step 206: The printhead is unqualified.

Moreover, the present invention can be implemented in the printhead with a resolution equal to or greater than 600 dpi with the length of the chip being equal to or greater than a quarter inch, especially for inspecting the number of nozzles equal to or greater than 150. However, the present invention is not limited to the conditions mentioned above. The present invention can also be implemented in other printheads with lower resolutions, shorter lengths of chips, and less nozzles.

Compared to the prior art, the present invention inspects that the number of damaged nozzles is equal to or less than two for printheads of high resolution and uses an interpolation to infer the rules mentioned above to detect if positions of dots printed by the two damaged nozzles are adjacent on the print-medium. In other words, the present invention can avoid poor printing quality, such as the blank area 8 of FIG. 1. In addition, the present invention designs test patterns, such as FIG. 3 to FIG. 6 and FIG. 8 to FIG. 10, for operators speedily and precisely to inspect printheads with the naked eye. A scanner may also used in the present invention to scan test patterns, such as FIG. 3 and FIG. 8, for speedily inspecting printheads.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for inspecting whether a printhead of a printer conforms to a specification, the printhead having nozzles 1 to N, the method comprising:
(a) detecting if the number of damaged nozzles of the printhead is two;
(b) if the number of damaged nozzles of the printhead is two, N is an even number, one of the damaged nozzle is nozzle n, and after the printhead completes a printing pass on a print-medium, the moving distance of the print-medium that will allow the printhead to perform the next printing pass is equal to the distance from said nozzle 1 to the middle of nozzle N/2 and nozzle (N+2)/2, or equal to the distance from said nozzle 1 to the middle of said nozzle (N+2)/2 and nozzle (N+4)/2, detecting if said nozzle n and the other damaged nozzle conform to one of three rules (a1) to (a3):
(a1) when n=1 to N/2−1, the other damaged nozzle is nozzle N/2+n−1, nozzle N/2+n, or nozzle N/2+n+1;
(a2) when n=N/2, the other damaged nozzle is nozzle N−1 or said nozzle N; and
(a3) when n=N/2+1, the other damaged nozzle is said nozzle N; and
(c) if the number of damaged nozzles of the printhead is two, N is an odd number, one of the damaged nozzles is said nozzle n, and after the printhead completes a printing pass on a print-medium, the moving distance of the print-medium that will allow the printhead to perform the next printing pass is equal to the distance from said nozzle 1 to the middle of nozzle (N+1)/2 and nozzle (N+3)/2, detecting if said nozzle n and the other damaged nozzle conform to one of two rules (b1) to (b2):
(b1) when n=1 to (N−1)/2, the other damaged nozzle is nozzle (N−1)/2+n or nozzle (N+1)/2+n; and
(b2) when n=(N+1)/2, the other damaged nozzle is said nozzle N.

2. The method of claim 1 wherein step (a) further comprises each of nozzles of the printhead jetting ink on the print-medium for detecting the number of damaged nozzles.

3. The method of claim 2 further comprising scanning the print-medium for detecting which nozzles are damaged.

4. The method of claim 1 wherein step (b) further comprises printing test patterns conforming to the rules (a1) to (a3) on the print-medium.

5. The method of claim 1 wherein step (c) further comprises printing test patterns conforming to the rules (b1) to (b2) on the print-medium.

6. A method for inspecting whether a printhead of a printer conforms to a specification, the printhead having N nozzles, the method comprising:
(a) detecting if the printhead has two damaged nozzles conforming to one of three rules
(a1) to (a3):
(a1) one of the damaged nozzles is nozzle n while the other damaged nozzle is nozzle N/2+n−1, nozzle N/2+n, or nozzle N/2+n+1, wherein n=1 to N/2−1;
(a2) one of the damaged nozzles is nozzle N/2 while the other damaged nozzle is nozzle N−1, or nozzle N; and
(a3) one of the damaged nozzles is nozzle N/2+1 while the other damaged nozzle is said nozzle N.

7. The method of claim 6 further comprising if the printhead has two damaged nozzles conforming to one of the three rules (a1) to (a3), determining the printhead unqualified.

8. The method of claim 6 further comprising:
(b) detecting if the number of damaged nozzles of the printhead is two.

9. The method of claim 8 wherein step (b) further comprises each of nozzles of the printhead jetting ink on the print-medium for detecting the number of damaged nozzles.

10. The method of claim 9 further comprising scanning the print-medium for detecting which nozzles are damaged.

11. The method of claim 6 wherein step (a) further comprises printing test patterns conforming to the rules (a1) to (a3) on the print-medium.

12. A method for inspecting whether a printhead of a printer conforms to a specification, the printhead having N nozzles, the method including:
(a) detecting if the printhead has two damaged nozzles conforming to one of two rules (b1) to (b2):
(b1) one of the damaged nozzles is nozzle n while the other damaged nozzle is nozzle (N−1)/2+n or nozzle (N+1)/2+n, wherein n=1 to (N−1)/2; and
(b2) one of the damaged nozzles is nozzle (N+1)/2 while the other damaged nozzle is nozzle N.

13. The method of claim 12 further comprising if the printhead has two damaged nozzles conforming to one of the two rules (b1) to (b2), determining the printhead unqualified.

14. The method of claim 12 further comprising:
(b) detecting if the number of damaged nozzles of the printhead is two.

15. The method of claim 14 wherein step (b) further comprises each of nozzles of the printhead jetting ink on the print-medium for detecting the number of damaged nozzles.

16. The method of claim 15 further comprising scanning the print-medium for detecting which nozzles are damaged.

17. The method of claim 12 wherein step (a) further comprises printing test patterns conforming to the rules (b1) to (b2) on the print-medium.

18. A printer comprising:
a printhead having N nozzles; and
a logic unit used for:
(a) detecting if the printhead has two damaged nozzles conforming to one of three rules (a1) to (a3):
(a1) one of the damaged nozzles is nozzle n while the other damaged nozzle is nozzle N/2+n−1, nozzle N/2+n, or nozzle N/2+n+1, wherein n=1 to N/2−1;
(a2) one of the damaged nozzles is nozzle N/2 while the other damaged nozzle is nozzle N−1 or nozzle N; and
(a3) one of the damaged nozzles is nozzle N/2+1 while the other damaged nozzle is said nozzle N.

19. The printer of claim 18 wherein the logic unit is further used for detecting if the printhead has two damaged nozzles conforming to one of the three rules (a1) to (a3) making the printhead unqualified.

20. The printer of claim 18 wherein the logic unit is further used for:
(b) detecting if the number of damaged nozzles of the printhead is two.

21. A printer comprising:
a printhead having N nozzles; and
a logic unit used for:
(a) detecting if the printhead has two damaged nozzles conforming to one of two rules (b1) to (b2):
(b1) one of the damaged nozzles is nozzle n while the other damaged nozzle is nozzle (N−1)/2+n or nozzle (N+1)/2+n, wherein n=1 to (N−1)/2; and
(b2) one of the damaged nozzles is nozzle (N+1)/2 while the other damaged nozzle is nozzle N.

22. The printer of claim 18 wherein the logic unit is further used for detecting if the printhead has two damaged nozzles conforming to one of the two rules (b1) to (b2) making the printhead unqualified.

23. The printer of claim 18 wherein the logic unit is further used for:
(b) detecting if the number of damaged nozzles of the printhead is two.
